(19) United States
(12) Patent Application Publication
(10) Pub. No.: US 2019/0387709 A1
(43) Pub. Date: Dec. 26, 2019

(54) MATERIAL DISCHARGE SYSTEM

(71) Applicant: SCHULER MFG. & EQUIP. CO. INC., Griswold, IA (US)

(72) Inventors: Reggie L. Schuler, Griswold, IA (US); Jared V. Dolch, Elliott, IA (US)

(21) Appl. No.: 16/448,561

(22) Filed: Jun. 21, 2019

Related U.S. Application Data
(60) Provisional application No. 62/688,485, filed on Jun. 22, 2018.

(51) Int. Cl. A01K 5/00; A01G 13/02; A01C 15/00; E04G 21/04

(52) U.S. Cl. CPC A01K 5/00; E04G 21/04; A01C 15/001; A01G 13/0287

(57) ABSTRACT

A material discharge system having at least one rotating member disposed within at least one chamber of a holding container. Each rotating member has a central hub with a plurality of arms that extend radially and transversely away from the central hub. The holding container has at least one discharge chamber.

### CROSS REFERENCE TO RELATED APPLICATION

This application claims the benefit of the priority of U.S. Provisional Application No. 62/688,485 filed on Jun. 22, 2018, the contents of these applications are hereby incorporated by reference in their entirety.

### BACKGROUND OF THE INVENTION

This invention is directed to a material discharge system, and more particularly a material discharge system that utilizes a rotary expeller or rotor for discharging materials out of a container.

Discharge systems, particularly for trucks, are known in the art and typically include a conveyor chain discharge box common with the bed of the truck. While useful, the conveyor chains are subject to corrosion and breakage which requires that the entire conveyor chain be replaced. Also, conveyor chains require a power source or drive that is complex, high in maintenance, and having a limited life. Accordingly, there is a need in the art for a device that addresses these deficiencies.

An objective of the present invention is to provide a material discharge system where parts can be easily replaced when worn.

Another objective of the present invention is to provide a material discharge system having a simple power source or drive.

These and other objectives will be apparent to those having ordinary skill in the art based upon the following written description, drawings and claims.

### SUMMARY OF THE INVENTION

A material discharge system includes at least one rotating member disposed within at least one chamber of a holding container. The rotating members have a central hub with a plurality of arms that extend radially and transversely away from the central hub. The central hub and the arms have a variety of shapes.

When more than one chamber is used, the chambers are either in communication with one another, or separated. In one example, the chambers are separated by a plurality of baffles. In another example, having separate chambers, material is transported from a chamber to a conveyance point by a conveyance mechanism where material is discharged from another chamber to the conveyance mechanism.

### BRIEF DESCRIPTION OF THE DRAWINGS

FIG. 1 is a top plan view of a material discharge system;

FIG. 1A is a top plan view of a material discharge system;

FIG. 1B is a top plan view of a material discharge system;

FIG. 1C is a top plan view of a material discharge system;

FIG. 2 is a top plan view of a material discharge system;

FIG. 2A is a side view of a material discharge system;

FIG. 2B is an end view of a material discharge system;

FIG. 3 is a top plan view of a material discharge system;

FIG. 3A is a side view of a material discharge system;

FIG. 3B is a perspective view of a material discharge system;

FIG. 3C is a perspective view of a material discharge system;

FIG. 4 is a top plan view of a material discharge system;

FIG. 4A is a side view of a material discharge system;

FIG. 4B is an end view of a material discharge system;

FIG. 5 is a top plan view of a material discharge system;

FIG. 5A is a side view of a material discharge system;

FIG. 6 is a top plan view of a material discharge system;

FIG. 6A is a side view of a material discharge system; and

FIG. 7 is a perspective view of a rotating member.

### DETAILED DESCRIPTION

Referring to the Figures, are several examples of a material discharge system 10 for livestock feed that is mounted to a truck or a trailer (not shown). While a material discharge system 10 is shown with livestock feed, the system 10 is also used for a number of different applications. For example, the system 10 is also used to discharge wood chips and mulch, agricultural commodities, construction materials and the like. The system 10 can be adapted to discharge materials out of a container or multiple containers and into a complementing mixing device using augers, paddles, reels, beaters, rotors, and the like and/or combinations of mixing concepts for mobile or stationary systems. The system 10, generally, includes a rotating member 12, disposed within a holding container 14, that rotates about a vertical axis to expel feed stuffs and other material from the holding container 14. The holding container 14 is of any type including a tank, a tub, a box, or the like.

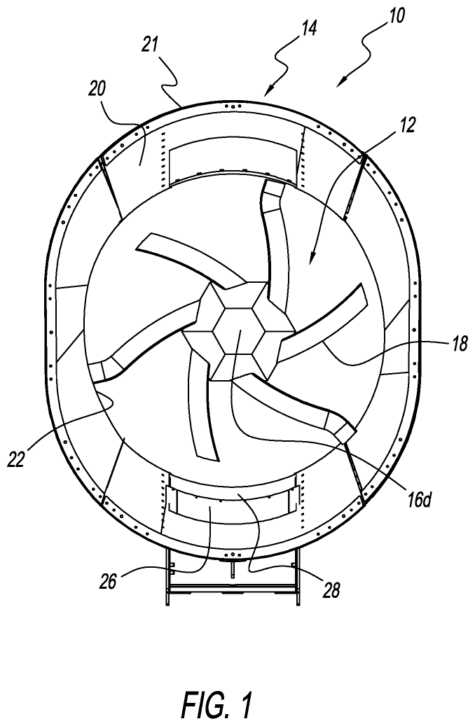

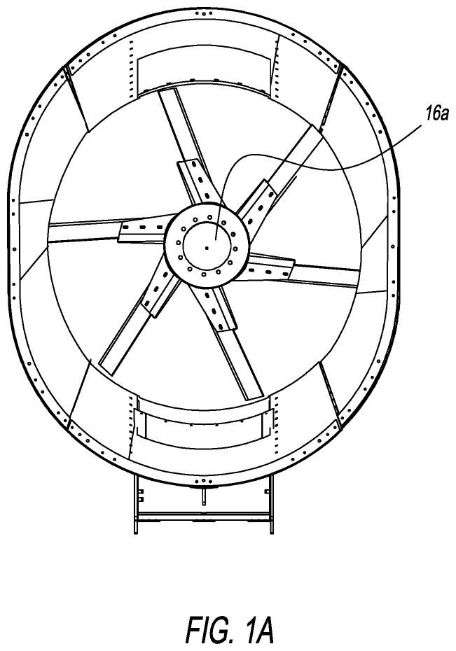

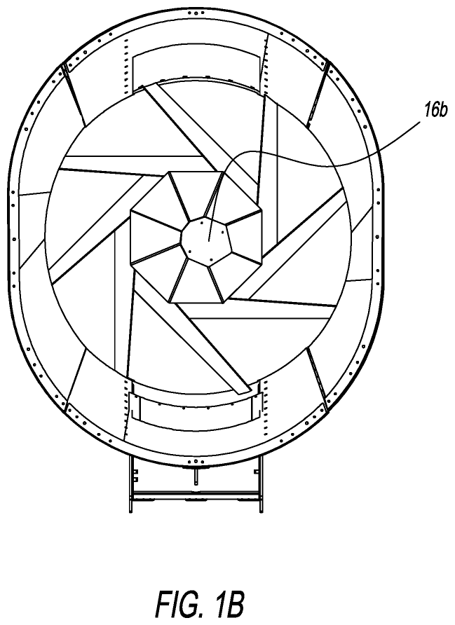

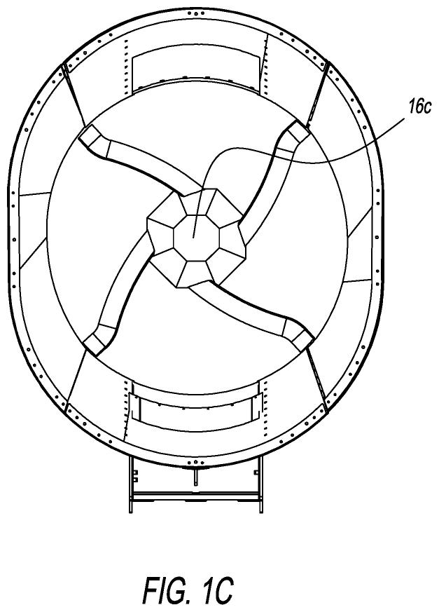

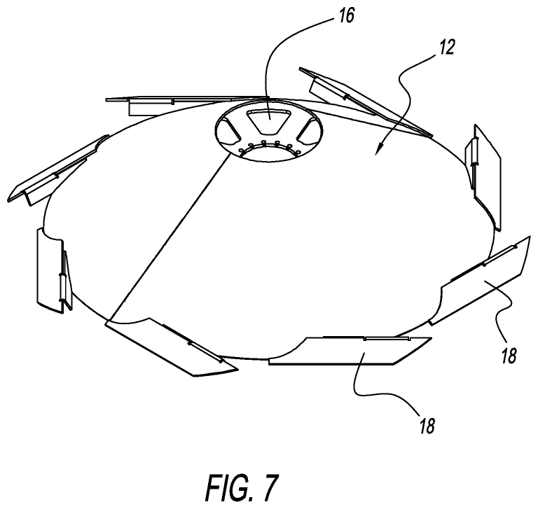

In a first example, as shown in FIG. 1, the rotational member 12 has a central hub 16 driven rotationally by a power source (not shown). As shown in multiple examples set forth in FIGS. 1, 1A, 1B, and 10, the central hub 16 is of different shapes, structures and sizes including circular 16a, a plurality of trapezoidal 16b, off-set trapezoidal 16c, starfish shape 16d or the like. As shown in FIG. 7, a preferred design of the rotating member 12 is one having a cone shape that is smooth with no facets. Extending radially and transversely from the central hub 16 are a plurality of vanes or arms 18. The arms 18 are of any size, shape, and structure and preferably extend from the central hub 16 to the inner surface 20 of a continuous side wall 21 of the holding container 14 leaving a space 22 to permit the rotation of the rotating member 12 without interference from the holding container 14. Disposed within the continuous side wall 21 of the holding container 14 is a moveable discharge door 26 adjacent and aligned with a discharge opening 28 that extends outwardly and transversely from the side wall 21. As the rotating member 12 rotates the arms 18 the commodity is forced in a radial direction by the arms 18 and subsequently out the discharge opening. While the Figure shows a single chambered container, a container 14 with a plurality of chambers can also be used.

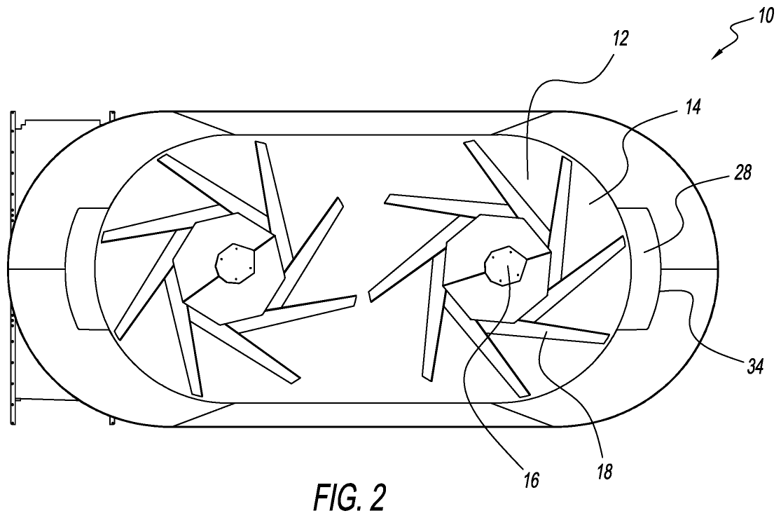

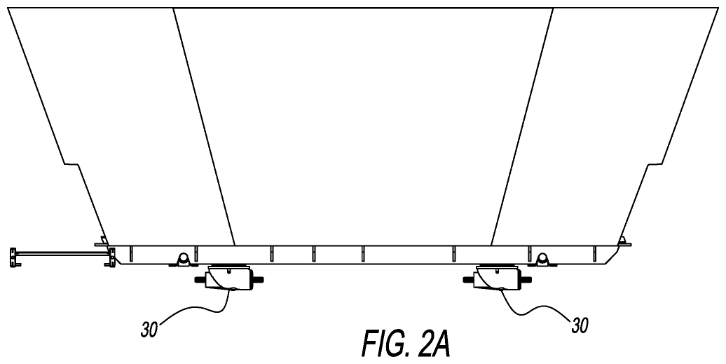

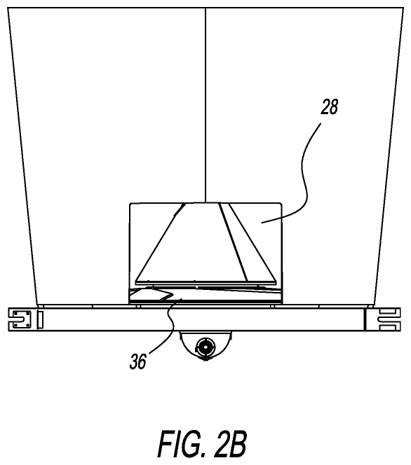

In a second example as shown in FIGS. 2, 2A, and 2B, the container 14 includes multiple rotational members 12 driven by rotational drive mechanisms 30. The rotational members 12 are disposed within separate partial chambers 32 that mate or communicate with one another. In this arrangement the rotating members 12 push the commodity or material to an end 34 of the container 14 through a discharge opening 28. To assist in the discharge of the material, a conveyor 36 is positioned at the end 34 of the container 14 to move the material to one side of the container 14 or the other. The conveyor 36 is of any type such as belts, chain, slat, auger, or the like.

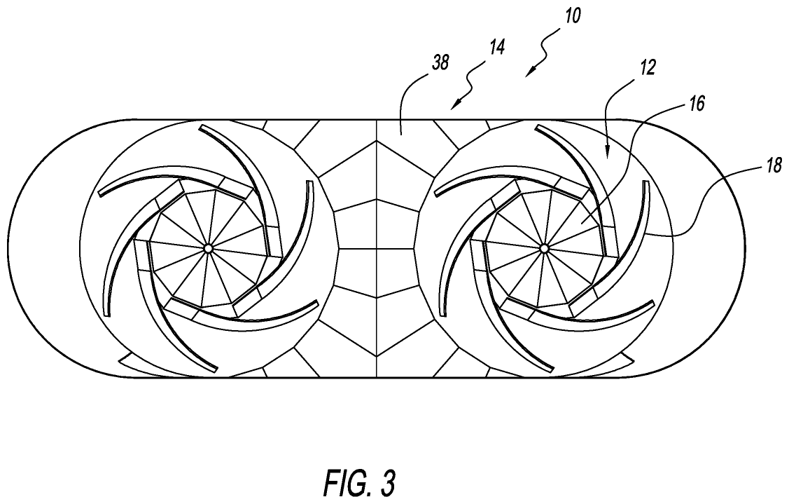

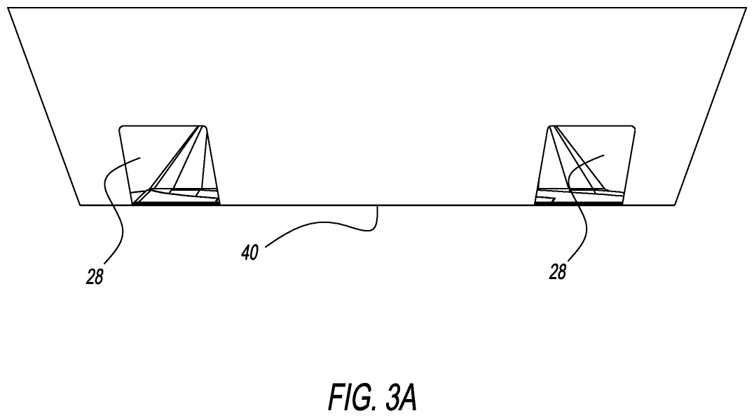

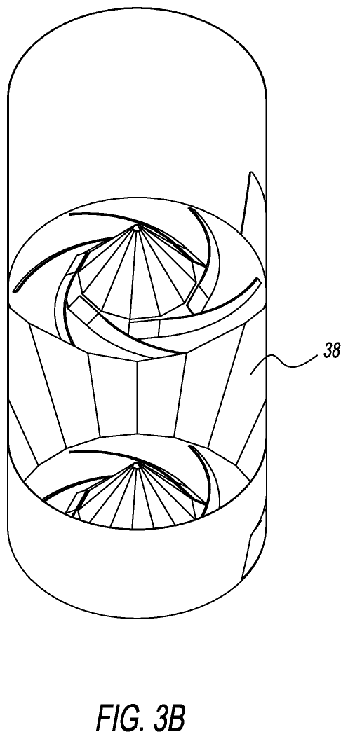

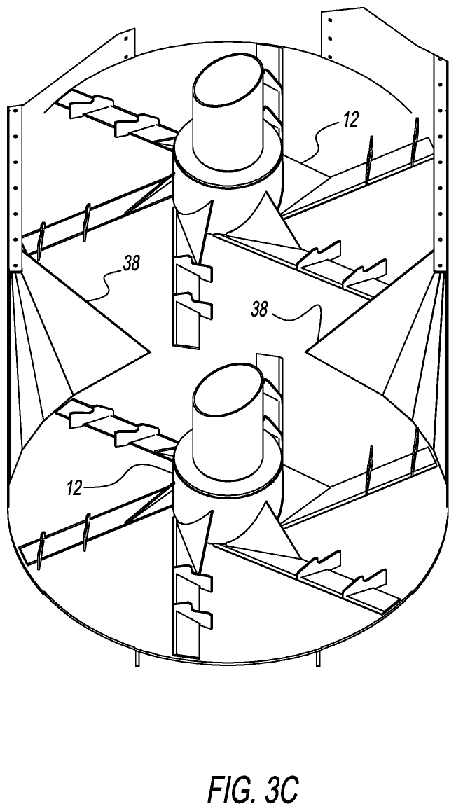

In another example, as shown in FIGS. 3, 3A, 3B, and 3C the container 14 has multiple chambers 32 that are partially separated by a plurality of baffles 38 positioned a partial distance above the floor 40 of the container 14. The baffles 38 are of any size, shape, and structure, and in one example, as shown in FIG. 3C they have a half pyramid shape. In particular the baffles 38 fill the area adjacent to, but not reached by, the rotating members 12. In this manner, feed does not sit in an unreachable area and instead is funneled toward the rotating members 12 by the angled walls of the baffles 38. Once the material in the container 14 is emptied to a level below a top edge of the baffles, the chambers 32 perform independently enhancing clean out characteristics. Each chamber 32 discharges material through its own respective discharge opening 28.

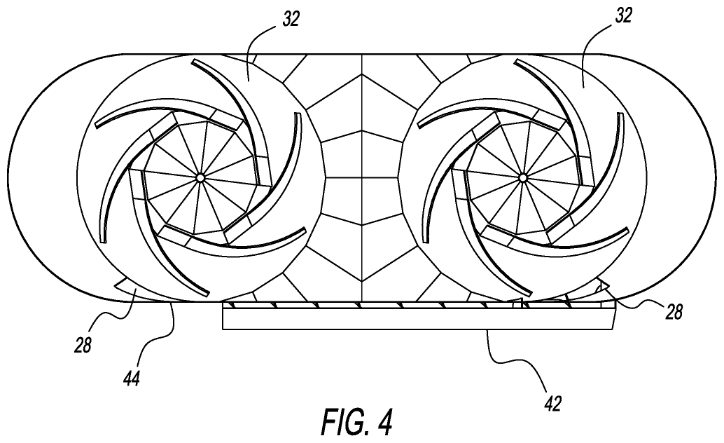

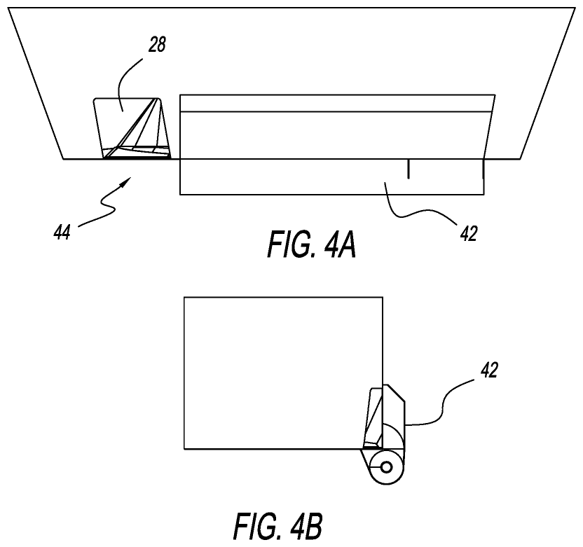

A variation of the system of FIG. 3 is shown in FIGS. 4, 4A, and 4B. In this example, a conveying mechanism 42 is positioned to transport discharged material from one chamber 32 to a conveyance point 44 where material is discharged by the other chamber 32 through the discharge opening 28. The conveyor mechanism 42 is external to the container 14 as shown, or alternatively, is internal or partially internal, to the container 14. Also, the conveyor mechanism is of any type such as a belt, chain, slat, auger or the like.

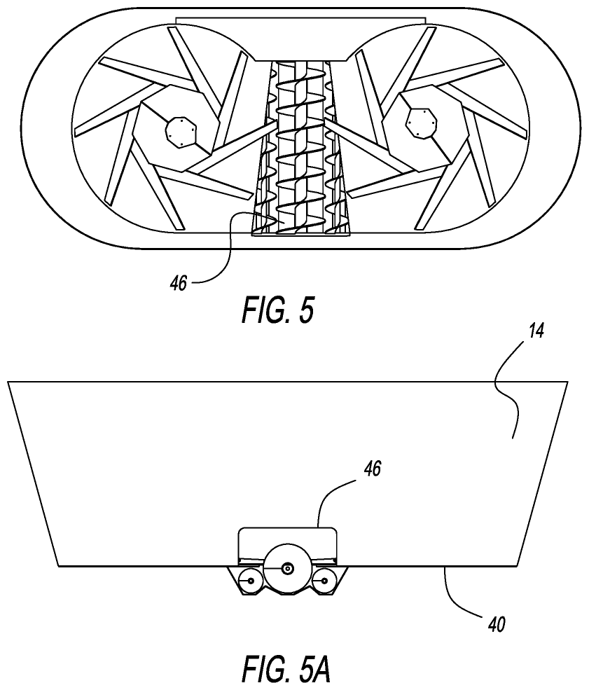

In another example, shown in FIGS. 5, and 5A, the chambers 32 do not mate, but instead feed material to a centrally located transverse conveying system 46 disposed through the floor 40 or the container 14. The transverse conveying system 46 conveys material out of the container 14 through a discharge opening 28. While the conveying system 46 is of any type, in the example shown in FIG. 5, the conveying system is comprised of a plurality of augers.

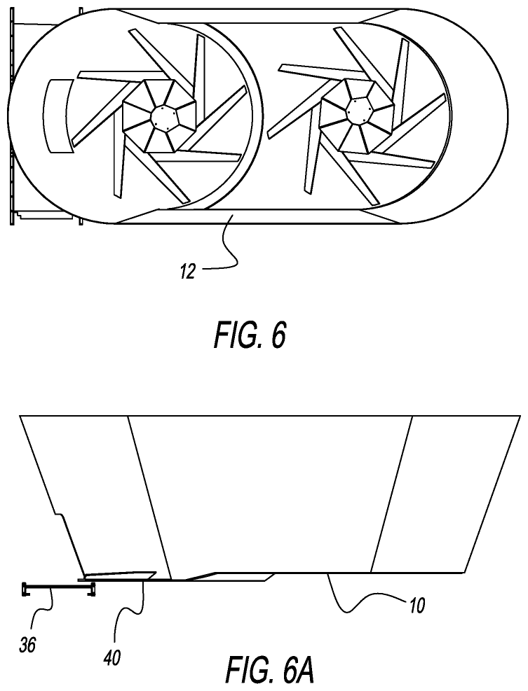

In yet another example, as shown in FIGS. 6, and 6A, the container 14 has multiple chambers 32 wherein the floor 40 of each successive chamber 32 is lower than the next furthest chamber 32 from the discharge end 34. Each chamber mates with, or is in communication with, the next chamber allowing material to be transferred from chamber 32 to chamber. The step floor arrangement created by the progressive lowering of the floor levels toward the discharge end 34 enhances movement toward the discharge end and clean out capabilities while obstructing movement of material in the opposite direction.

In a still further embodiment, the rotating member 12, as shown in FIG. 7, has a central hub 16 wherein the top 48 has an upside down cone or funnel shape. The outer surface 50 of the top 48 is smooth having no edges. The arms 18 are attached to the central hub 16 and extend outwardly and at an angle in relation to the central hub 16.

In a still further embodiment, the rotating member of the various embodiments has arms that are able to retract and extend or fold in and out in response to pressure of the material being discharged or in reaction to the rotating speed of the rotor or in reaction to an obstruction encountered by the arms to prevent their damage.

These examples of rotor design do not represent all the modifications that could be done to the rotor for potential applications known now or that may become known in the future.

From the above discussion and accompanying figures and claims it will be appreciated that the material discharge system 10 offers many advantages over the prior art. It will be appreciated further by those skilled in the art that other various modifications could be made to the device without parting from the spirit and scope of this invention. All such modifications and changes fall within the scope of the claims and are intended to be covered thereby. It should be understood that the examples and embodiments described herein are for illustrative purposes only and that various modifications or changes in the light thereof will be suggested to persons skilled in the art and are to be included in the spirit and purview of this application.

What is claimed is:

1. A material discharge system, comprising:
a rotating member disposed within a holding container;
the rotating member having a central hub and a plurality of arms that extend radially and transversely away from the central hub to an inner surface of a side wall of the holding container leaving a space to permit rotation of the rotating member without interference from the holding container; and
a discharge conveyor disposed within the holding container adjacent a discharge opening in the holding container.

2. The system of claim 1 wherein the central hub has a shape selected from a group consisting of circular, a plurality of trapezoidal, off-set trapezoidal, and starfish.

3. The system of claim 1 wherein the discharge opening extends outwardly and transversely.

4. The system of claim 1 wherein the central hub of the rotating member has a top with a funnel shape.

5. The system of claim 4 wherein an outer surface of the top is smooth having no edges.

6. A material discharge system, comprising:
multiple rotational members, disposed within separate partial chambers in communication with one another of a holding container;
the multiple rotational members each having a central hub and a plurality of arms that extend radially and transversely away from the central hub;
wherein the rotating members are adapted to push a material to an end of the holding container having a discharge opening.

7. The system of claim 6 further comprising a conveyor positioned at the end of the holding container adjacent the discharge opening and adapted to move the material to a side of the holding container.

8. The system of claim 6 wherein a floor of each successive partial chamber is lower than a next partial chamber from the end of the holding container having the discharge opening.

9. A material discharge system, comprising:
multiple rotational members disposed within separate partial chambers; and
a plurality of baffles positioned between the separate partial chambers.

10. The system of claim 9 wherein each separate partial chamber has a discharge opening.

11. A material discharge system, comprising:
multiple rotational members disposed within separate partial chambers of a holding container; and
a conveyor mechanism positioned and adapted to transport discharged material from one of the separate partial chambers to a conveyance point where material is discharged by another separate partial chamber.

12. The system of claim 11 wherein the conveyor mechanism is external to the holding container.
